(19) United States
(12) Patent Application Publication
(10) Pub. No.: US 2008/0168839 A1
(43) Pub. Date: Jul. 17, 2008

(54) ULTRASONIC DIAGNOSTIC APPARATUS

(75) Inventor: Kimito KATSUYAMA, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/969,484

(22) Filed: Jan. 4, 2008

(30) Foreign Application Priority Data
Jan. 12, 2007 (JP) 2007-004724

(51) Int. Cl. G01N 29/44

(52) U.S. Cl. 73/602

(57) ABSTRACT

An ultrasonic diagnostic apparatus capable of detecting a boundary between structures within the object with high accuracy and performing imaging processing based thereon. The ultrasonic diagnostic apparatus includes: a transmission and reception unit for converting reception signals outputted from ultrasonic transducers into digital signals; a phase matching unit for performing reception focus processing on the digital signals to generate sound ray signals; a signal processing unit for performing envelope detection processing on the sound ray signals to generate envelope signals; an image data generating unit for generating image data based on the envelope signals; a direction determining unit for determining a direction of a boundary between structures within the object based on the sound ray signals; and an image processing unit for performing image processing on the envelope signals or the image data according to a determination result obtained by the direction determining unit.

### BACKGROUND OF THE INVENTION

1. Field of the Invention

The present invention relates to an ultrasonic diagnostic apparatus for imaging organs, bones, and so on within a living body by transmitting and receiving ultrasonic waves to generate ultrasonic images to be used for diagnoses.

2. Description of a Related Art

In medical fields, various imaging technologies have been developed for observation and diagnoses within an object to be inspected. Especially, ultrasonic imaging for acquiring interior information of the object by transmitting and receiving ultrasonic waves enables image observation in real time and provides no exposure to radiation unlike other medical image technologies such as X-ray photography or RI (radio isotope) scintillation camera. Accordingly, ultrasonic imaging is utilized as an imaging technology at a high level of safety in a wide range of departments including not only the fetal diagnosis in obstetrics, but also gynecology, circulatory system, digestive system, and so on.

The principle of ultrasonic imaging is as follows. Ultrasonic waves are reflected at a boundary between regions having different acoustic impedances like a boundary between structures within the object. Therefore, by transmitting ultrasonic beams into the object such as a human body, receiving ultrasonic echoes generated within the object, and obtaining reflection points where the ultrasonic echoes are generated and reflection intensity, outlines of structures (e.g., internal organs, diseased tissues, and so on) existing within the object can be extracted.

As a related technology, Japanese Patent Application Publication JP-2004-242836A discloses an ultrasonic diagnostic apparatus for constantly obtaining good ultrasonic tomographic images by adaptively performing smoothing processing and edge enhancement processing according to an object. The ultrasonic diagnostic apparatus obtains, with respect to each point to be displayed, variance values of intensity of reflection signals from the respective locations within the object in different directions through the point, obtains the minimum variance value among the variance values, obtains an orthogonal variance value in the orthogonal direction, determines whether or not the orthogonal variance value is larger than a predetermined value, and determines that there is a periphery in the direction of the minimum variance value when the orthogonal variance value is larger than the predetermined value so as to perform smoothing processing in the periphery direction and edge enhancement processing in a direction orthogonal to the periphery direction. However, according to JP-2004-242836A, boundary detection is performed based only on the amplitude of a B-mode image signal obtained by performing envelope detection processing or the like on an RF signal based on ultrasonic echoes from the object, and therefore, there are problems that the amount of information is limited and the detection accuracy in boundary detection can hardly be made higher.

### SUMMARY OF THE INVENTION

In view of the above-mentioned problems, a purpose of the present invention is to provide an ultrasonic diagnostic apparatus capable of detecting a boundary between structures within the object with high accuracy and performing imaging processing based thereon.

In order to accomplish the above-mentioned purpose, an ultrasonic diagnostic apparatus according to one aspect of the present invention includes: a transmission and reception unit for respectively supplying drive signals to plural ultrasonic transducers for transmitting ultrasonic waves to an object to be inspected, and converting reception signals respectively outputted from the plural ultrasonic transducers having received ultrasonic echoes from the object into digital signals; phase matching means for performing reception focus processing on the digital signals to generate sound ray signals corresponding to plural reception lines; signal processing means for performing envelope detection processing on the sound ray signals generated by the phase matching means to generate envelope signals; image data generating means for generating image data based on the envelope signals generated by the signal processing means; direction determining means for determining a direction of a boundary between structures within the object based on the sound ray signals generated by the phase matching means; and image processing means for performing image processing on the envelope signals or the image data according to a determination result obtained by the direction determining means.

According to the present invention, the direction of the boundary between structures within the object is determined based on the sound ray signals corresponding to the plural reception lines, and therefore, the boundary between structures within the object can be detected with high accuracy and imaging processing can be performed based thereon.

### BRIEF DESCRIPTION OF THE DRAWINGS

FIG. 1 is a block diagram showing a configuration of an ultrasonic diagnostic apparatus according to the first embodiment of the present invention;

FIG. 2 is a block diagram showing a first configuration example of a direction determining unit shown in FIG. 1;

FIGS. 3 and 4 are diagrams for explanation of computation in the direction determining unit shown in FIG. 1;

FIG. 5 is a block diagram showing a second configuration example of the direction determining unit shown in FIG. 1;

FIG. 6 is a block diagram showing a third configuration example of the direction determining unit shown in FIG. 1;

FIG. 7 is a block diagram showing a configuration of an ultrasonic diagnostic apparatus according to the second embodiment of the present invention;

FIG. 8 is a block diagram showing a first configuration example of a direction determining unit shown in FIG. 7;

FIG. 9 is a block diagram showing a second configuration example of a direction determining unit shown in FIG. 7;

FIG. 10 is a block diagram showing a third configuration example of a direction determining unit shown in FIG. 7;

FIG. 11 shows a difference in amount of information between sound ray signals and envelope signals.

### DESCRIPTION OF THE PREFERRED EMBODIMENTS

Hereinafter, preferred embodiments of the present invention will be explained in detail with reference to the drawings. The same reference numbers are assigned to the same component elements and the description thereof will be omitted.

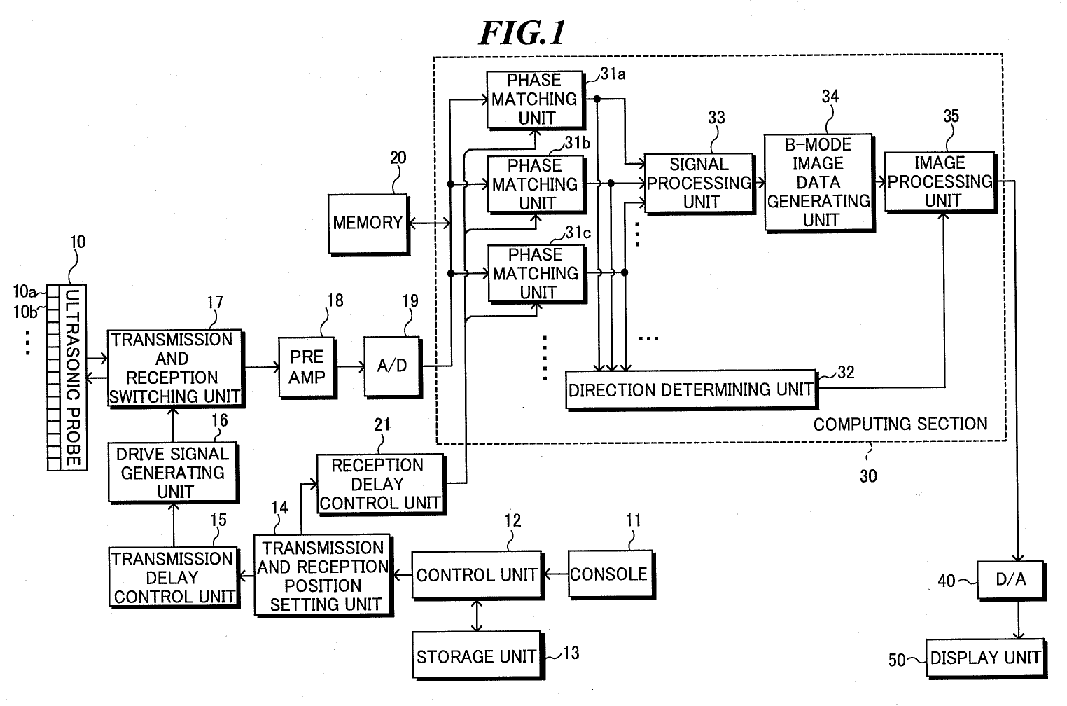

FIG. 1 is a block diagram showing a configuration of an ultrasonic diagnostic apparatus according to the first embodiment of the present invention. The ultrasonic diagnostic apparatus according to the embodiment has an ultrasonic probe 10, a console 11, a control unit 12, a storage unit 13, a transmission and reception position setting unit 14, a transmission delay control unit 15, a drive signal generating unit 16, a transmission and reception switching unit 17, a preamplifier (PREAMP) 18, an A/D converter 19, a memory 20, a reception delay control unit 21, a computing section 30, a D/A converter 40, and a display unit 50.

The ultrasonic probe 10 is used in contact with an object to be inspected, and transmits ultrasonic beams toward the object and receives ultrasonic echoes from the object. The ultrasonic probe 10 includes plural ultrasonic transducers 10a, 10b, . . . that transmit ultrasonic waves to the object according to applied drive signals, and receive propagating ultrasonic echoes to output reception signals. These ultrasonic transducers 10a, 10b, . . . are one-dimensionally or two-dimensionally arranged to form a transducer array.

Each ultrasonic transducer is configured by a vibrator in which electrodes are formed on both ends of a material having a piezoelectric property (piezoelectric material) such as a piezoelectric ceramic represented by PZT (Pb (lead) zirconate titanate), a polymeric piezoelectric element represented by PVDF (polyvinylidene difluoride), or the like. When a voltage of pulsed or continuous wave is applied to the electrodes of the vibrator, the piezoelectric material expands and contracts. By the expansion and contraction, pulsed or continuous ultrasonic waves are generated from the respective vibrators, and an ultrasonic beam is formed by synthesizing these ultrasonic waves. Further, the respective vibrators expand and contract by receiving propagating ultrasonic waves to generate electric signals. These electric signals are outputted as reception signals of the ultrasonic waves.

The console 11 includes a keyboard, an adjustment knob, a mouse, and so on, and is used when an operator inputs commands and information to the ultrasonic diagnostic apparatus. The control unit 12 controls the respective units of the ultrasonic diagnostic apparatus based on the commands and information inputted by using the console 11. In the embodiment, the control unit 12 is configured by a central processing unit (CPU) and software for activating the CPU to perform various kinds of processing. The storage unit 13 stores programs for activating the CPU to execute operations and soon, by employing hard disk, flexible disk, MO, MT, RAM, CD-ROM, DVD-ROM, or the like as a recording medium.

The transmission and reception position setting unit 14 can set at least one transmission direction of an ultrasonic beam to be transmitted from the ultrasonic probe 10, at least one reception direction, a focal depth, and an aperture diameter of the ultrasonic transducer array when a predetermined imaging region within the object is scanned by the ultrasonic beam. In this case, the transmission delay control unit 15 sets delay times (a delay pattern) to be provided to drive signals for transmission focus processing according to the transmission direction of the ultrasonic beam, the focal depth, and the aperture diameter that have been set by the transmission and reception position setting unit 14.

The drive signal generating unit 16 includes plural drive circuits for respectively generating drive signals to be supplied to the ultrasonic transducers 10a, 10b, . . . based on the delay times that have been set by the transmission delay control unit 15. The transmission and reception switching unit 17 switches between a transmission mode of supplying drive signals to the ultrasonic probe 10 and a reception mode of receiving reception signals from the ultrasonic probe 10 under the control of the control unit 12.

In the embodiment, the phase relationship of sound ray signals among a predetermined number of pixels surrounding each reception focus is used for obtaining a boundary between structures. Accordingly, it is necessary to synthesize (i) the phase of the ultrasonic beam to be transmitted with (ii) the transmission start timing in the respective directions in scanning of the object. Alternatively, the ultrasonic waves to be transmitted at once from the ultrasonic transducers 10a, 10b, . . . may be allowed to reach the entire imaging region of the object. As below, the latter case will be explained.

The preamplifier 18 and the A/D converter 19 have plural channels corresponding to the plural ultrasonic transducers 10a, 10b, . . . , and input reception signals to be outputted from the ultrasonic transducers 10a, 10b, . . . , respectively, perform preamplification and analog/digital conversion on the respective reception signals, thereby generate digital reception signals (RF data), and stores them in the memory 20.

The reception delay control unit 21 has plural delay patterns (phase matching patterns) according to the reception direction and the focal depth of ultrasonic echoes, and selects delay times (a delay pattern) to be provided to the reception signals according to the plural reception directions and the focal depth set by the transmission and reception position setting unit 14, and supplies them to the computing section 30.

The computing section 30 includes plural phase matching units 31a, 31b, 31c, . . . provided in parallel for higher processing speed, a direction determining unit 32, a signal processing unit 33, a B-mode image data generating unit 34, and an image processing unit 35. The computing section 30 may be configured by a CPU and software, or configured by a digital circuit or analog circuit.

Each of the phase matching units 31a, 31b, 31c, performs reception focus processing by reading out the reception signals of the plural channels stored in the memory 20, providing the respective delays to the reception signals based on the delay pattern supplied from the reception delay control unit 21, and adding them to one another. Through the reception focus processing, sound ray signals (sound ray data), in which the focal point of the ultrasonic echoes is narrowed, are formed.

The direction determining unit 32 sequentially sets regions having predetermined sizes surrounding each reception focus (corresponding to a pixel) sequentially formed by one of the phase matching units 31a, 31b, 31c, . . . in the imaging region, in order to determine the direction of a boundary between structures. The region is assumed to include M×N pixels. Here, each of M and N is an integral number equal to or more than “2”, and may be M=N=3, 4, 5, . . . , for example. The plural regions to be sequentially selected may overlap with one another, or may be adjacent without overlapping. As below, the case where the plural regions to be sequentially selected are adjacent to one another will be explained.

The direction determining unit 32 determines the direction of the boundary between structures within the object based on the values of the sound ray signals in the M×N pixels within each region. In the embodiment, since the phase matching units 31a, 31b, 31c, . . . are provided, M kinds or N kinds of sound ray signals can be obtained in parallel. In the following, the case where M=N=3 will be explained.

The signal processing unit 33 generates envelope signals (envelope data) by sequentially selecting one of the three kinds of sound ray signals (corresponding to three reception lines) outputted from the phase matching units 31a, 31b, 31c in parallel, performing attenuation correction by a distance according to the depth of the reflection position of ultrasonic waves by STC (sensitivity time gain control) on the sound ray signals, and then, performing envelope detection processing with a low-pass filter or the like. In the case where the sequentially selected plural regions are shifted by one pixel, the signal processing unit 33 can sequentially generate envelope signals corresponding to the plural reception lines based on one kind of sound ray signal (corresponding to one reception line) outputted from the phase matching unit 31b, for example.

The B-mode image data generating unit 34 performs pre-process processing such as Log (logarithmic) compression and gain adjustment on the envelope signal outputted from the signal processing unit 33 to generate B-mode image data, and converts (raster-converts) the generated B-mode image data into image data that follows the normal scan system of television signals to generate image data for display.

The image processing unit 35 performs image processing on the image data outputted from the B-mode image data generating unit 34 according to the determination result obtained by the direction determining unit 32. The D/A converter 40 converts the image data for display outputted from the computing section 30 into an analog image signal, and outputs it to the display unit 50. Thereby, an ultrasonic image is displayed on the display unit 50.

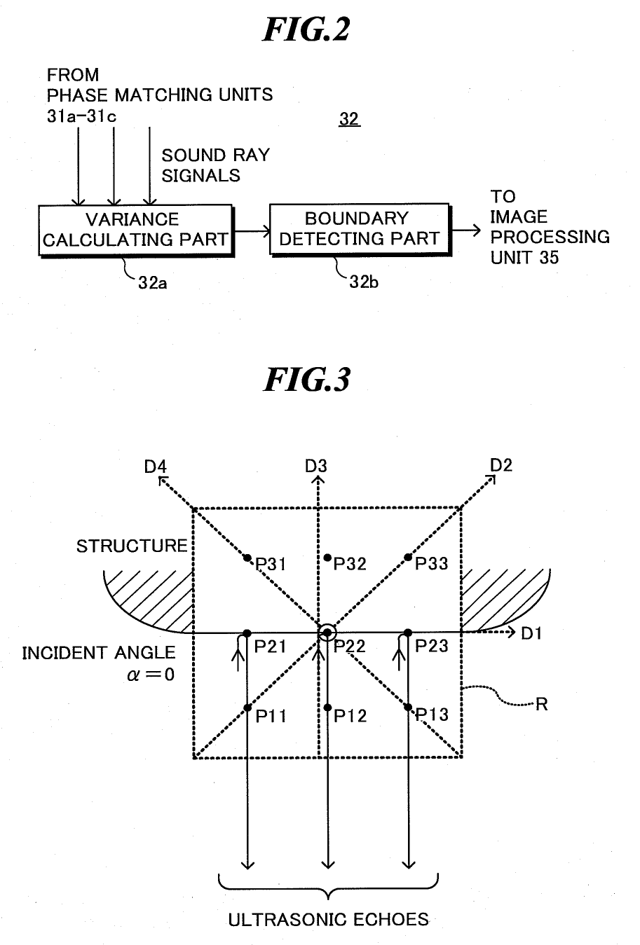

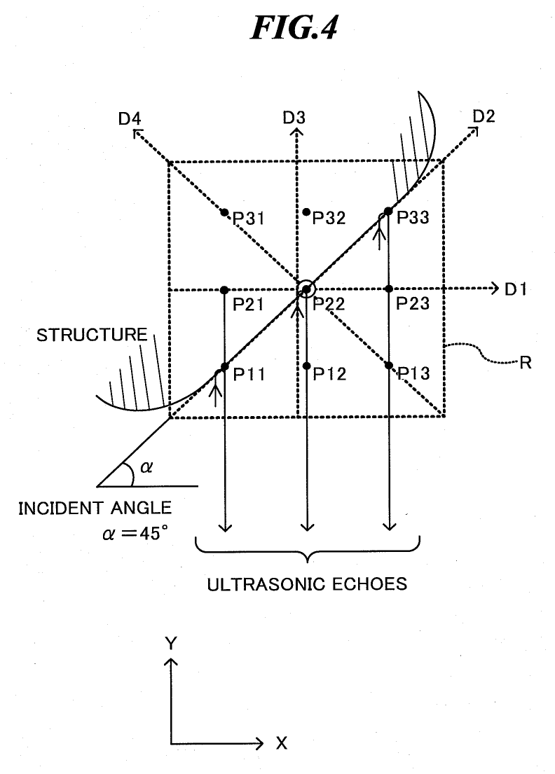

FIG. 2 is a block diagram showing a first configuration example of the direction determining unit shown in FIG. 1, and FIGS. 3 and 4 are diagrams for explanation of computation in the direction determining unit. In the first configuration example, the direction determining unit 32 includes a variance calculating part 32a and a boundary detecting part 32b. The variance calculating part 32a calculates variances of values of the sound ray signals in plural different directions with respect to a predetermined number of pixels surrounding each of the reception focuses sequentially formed by the phase matching unit 31b. The boundary detecting part 32b detects a boundary between structures within the object based on the maximum value and the minimum value in the variances calculated by the variance calculating part 32a.

FIG. 3 shows pixel P22 as one of the plural reception focuses (pixels) sequentially formed by the phase matching unit 31b, and a region “R” as a selected two-dimensional region around the pixel P22. The region “R” includes 3×3 pixels P11-P33.

The phase matching unit 31a performs reception focus processing so as to sequentially focus on the pixels P11-P31 in the first row, the phase matching unit 31b performs reception focus processing so as to sequentially focus on the pixels P12-P32 in the second row, and the phase matching unit 31c performs reception focus processing so as to sequentially focus on the pixels P13-P33 in the third row. Instead of providing plural phase matching units, focusing on the pixels P11-P33 in the three rows may be performed by using one phase matching unit.

In FIG. 3, ultrasonic echoes generated when the transmission beam of ultrasonic waves is reflected at the pixels P11-P33 within the object are received by the ultrasonic probe. Here, given that values of the sound ray signals at the pixels P11-P33 are E11-E33, respectively, an average value A1 of the values E21-E23 of the sound ray signals at the pixels P21-P23 arranged in the first direction D1 is expressed by the following equation.

A1=(E21+E22+E23)/3

A variance σ1 of the values E21-E23 of the sound ray signals at the pixels P21-P23 arranged in the first direction D1 is expressed by the following equation.

σ1={(E21−A1)²+(E22−A1)²+(E23−A1)²}/3

Similarly, an average value A2 of the values E11-E33 of the sound ray signals at the pixels P11-P33 arranged in the second direction D2 is expressed by the following equation.

A2=(E11+E22+E33)/3

A variance σ2 of the values E11-E33 of the sound ray signals at the pixels P11-P33 arranged in the second direction D2 is expressed by the following equation.

σ2={(E11−A2)²+(E22−A2)²+(E33−A2)²}/3

An average value A3 of the values E12-E32 of the sound ray signals at the pixels P12-P32 arranged in the third direction D3 is expressed by the following equation.

A3=(E12+E22+E32)/3

A variance σ3 of the values E12-E32 of the sound ray signals at the pixels P12-P32 arranged in the third direction D3 is expressed by the following equation.

σ3={(E12−A3)²+(E22−A3)²+(E32−A3)²}/3

An average value A4 of the values E13-E31 of the sound ray signals at the pixels P13-P31 arranged in the fourth direction D4 is expressed by the following equation.

A4=(E13+E22+E31)/3

A variance σ4 of the values E13-E31 of the sound ray signals at the pixels P13-P31 arranged in the fourth direction D4 is expressed by the following equation.

σ4={(E13−A4)²+(E22−A4)²+(E31−A4)²}/3

The variance calculating part 32a shown in FIG. 2 calculates the variances σ1-σ4 according to the above equations. The boundary detecting part 32b calculates, using the maximum value σ_{MAX} and the minimum value σ_{MIN} among the variances σ1-σ4 calculated by the variance calculating part 32a, a ratio of the maximum value to the minimum value σ_{MAX}/σ_{MIN} and compares the ratio with threshold value T1. The difference between the maximum value and the minimum value (σ_{MAX}−σ_{MIN}) may be used in place of the ratio of the maximum value to the minimum value σ_{MAX}/σ_{MIN}.

When the ratio of the maximum value to the minimum value σ_{MAX}/σ_{MIN} is equal to or more than threshold value T1, the boundary detecting part 32b determines that a boundary between structures exists within or near the region “R”, and determines the direction of the boundary between structures based on the direction that provides the minimum value σ_{MIN}.

As shown in FIG. 3, in the case where the incident angle “α” of the transmission beam to the structure is zero, the amplitudes and phases of ultrasonic echoes passing through the pixels P21-P23 arranged in the first direction D1 are equal to one another, and the variance σ1 takes an extremely small value. On the other hand, the amplitudes and phases of ultrasonic echoes passing through the pixels arranged in the other directions are random, and the variances σ2-σ4 take relatively large values. Therefore, when the ratio of the maximum value to the minimum value σ_{MAX}/σ_{MIN} is equal to or more than threshold value T1, the boundary between structures is detected. Further, it is found that the direction of the boundary between structures is nearly in parallel with the first direction D1 that provides the minimum value σ_{MIN}.

On the other hand, as shown in FIG. 4, in the case where the incident angle “α” of the transmission beam to the structure is 45°, the amplitudes and phases of ultrasonic echoes in the second direction D2 are equal to one another, and the variance σ2 takes an extremely small value. On the other hand, the amplitudes and phases of ultrasonic echoes passing through the pixels arranged in the other directions are random, and the variances σ1, σ3, σ4 take relatively large values. Therefore, when the ratio of the maximum value to the minimum value σ_{MAX}/σ_{MIN} is equal to or more than threshold value T1, the boundary between structures is detected. Further, it is found that the direction of the boundary between structures is nearly in parallel with the second direction D2 that provides the minimum value σ_{MIN}.

After the determination with respect to the region “R” is completed, the phase matching unit 31b shown in FIG. 1 performs reception focus processing to form the reception focus in a position shifted from the pixel P22 by three pixels in the X-axis direction. Accordingly, the direction determining unit 32 sets a new region including 3×3 pixels.

The image processing unit 35 performs image processing on the image data according to the determination result in the direction determining unit 32. For example, the image processing unit 35 may perform smoothing processing on the regions in which no boundary between structures has been detected by the boundary detecting part 32b. Further, the image processing unit 35 may perform smoothing processing in a direction in parallel with the direction of the boundary between structures determined by the direction determining unit 32, or may perform edge enhancement processing in a direction orthogonal to the direction of the boundary between structures. Thereby, in an ultrasonic image, the noise can be reduced without making the boundary between structures vague, or the boundary between structures can be made clear without increasing the noise so much.

FIG. 5 is a block diagram showing a second configuration example of the direction determining unit shown in FIG. 1. In the second configuration example, the direction determining unit 32 includes a difference value calculating part 32c and a boundary detecting part 32d. The difference value calculating part 32c calculates differences between the maximum values and the minimum values of the values of the sound ray signals in plural different directions with respect to a predetermined number of pixels surrounding each of the reception focuses sequentially formed by the phase matching unit 31b. The boundary detecting part 32d detects a boundary between structures within the object based on the differences between the maximum values and the minimum values calculated by the difference value calculating part 32c.

Referring to FIG. 4 again, the difference value calculating part 32c calculates difference ΔE1 between the maximum value and the minimum value of the values E21-E23 of the sound ray signals at the pixels P21-P23 arranged in the first direction D1, difference ΔE2 between the maximum value and the minimum value of the values E11-E33 of the sound ray signals at the pixels P11-P33 arranged in the second direction D2, difference ΔE3 between the maximum value and the minimum value of the values E12-E32 of the sound ray signals at the pixels P12-P32 arranged in the third direction D3, and difference ΔE4 between the maximum value and the minimum value of the values E13-E31 of the sound ray signals at the pixels P13-P31 arranged in the fourth direction D4.

The boundary detecting part 32d compares the differences ΔE1 to ΔE4 between the maximum values and the minimum values calculated by the difference value calculating part 32c with threshold value T2. When one of the differences ΔE1 to ΔE4 between the maximum values and the minimum values is equal to or less than the threshold value T2, the boundary detecting part 32d determines that a boundary between structures exists within or near the region “R” and determines the direction of the boundary between structures based on the direction in which the difference between the maximum value and the minimum value is equal to or less than the threshold value T2.

As shown in FIG. 4, the amplitudes and phases of ultrasonic echoes at the pixels P11-P13 arranged in the second direction D2 are equal to one another, and the difference ΔE2 between the maximum value and the minimum value of the sound ray signals at the pixels P11-P33 arranged in the second direction D2 takes an extremely small value. On the other hand, the amplitudes and phases of ultrasonic echoes passing through the pixels arranged in the other directions are random, and the differences ΔE1, ΔE3, ΔE4 between the maximum values and the minimum values of the sound ray signals take relatively large values. Therefore, the difference ΔE2 between the maximum value and the minimum value is equal to or less than the threshold value T2, and thereby, the boundary between structures is detected. Further, it is found that the direction of the boundary between structures is nearly in parallel with the second direction D2 in which the difference between the maximum value and the minimum value is equal to or less than the threshold value T2.

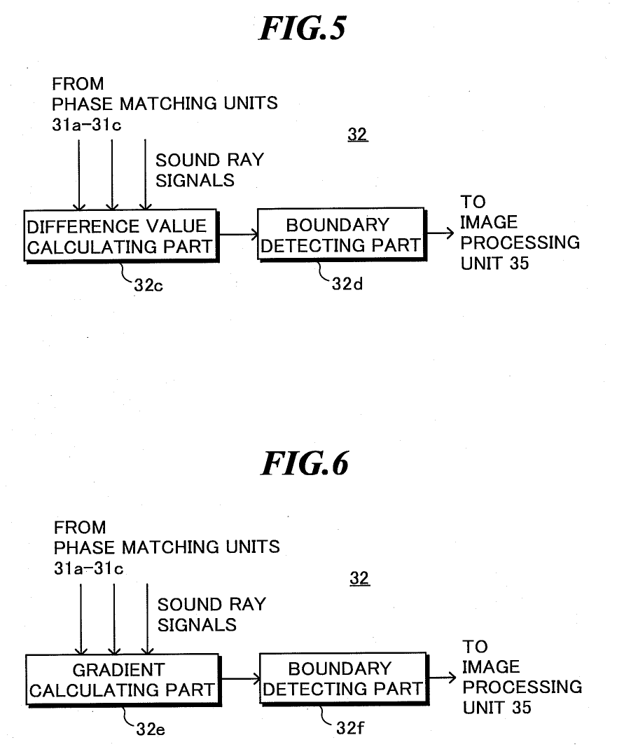

FIG. 6 is a block diagram showing a third configuration example of the direction determining unit shown in FIG. 1. In the third configuration example, the direction determining unit 32 includes a gradient calculating part 32e and a boundary detecting part 32f. The gradient calculating part 32e calculates gradients of the values of the sound ray signals in plural different directions with respect to a predetermined number of pixels surrounding each of the reception focuses sequentially formed by the phase matching unit 31b. The boundary detecting part 32f detects a boundary between structures within the object based on the gradients calculated by the gradient calculating part 32e.

Referring to FIG. 4 again, the gradient calculating part 32e calculates gradient G1 of the values E21-E23 of the sound ray signals at the pixels P21-P23 arranged in the first direction D1 by any one of the following equations (1) to (3), for example. Here, ΔX is a distance (fixed number) between two pixels adjacent in the X-axis direction.

G1=(E23−E21)/2ΔX (1)

G1={(E23−E22)/ΔX+(E22−E21)/ΔX}/2 (2)

G1=MAX {(E23−E22)/ΔX,(E22−E21)/ΔX} (3)

Similarly, the gradient calculating part 32e calculates gradient G2 of the values E11-E33 of the sound ray signals at the pixels P11-P33 arranged in the second direction D2, gradient G3 of the values E12-E32 of the sound ray signals at the pixels P12-P32 arranged in the third direction D3, and gradient G4 of the values E13-E31 of the sound ray signals at the pixels P13-P31 arranged in the fourth direction D4.

The boundary detecting part 32f compares the gradients G1 to G4 calculated by the gradient calculating part 32e with threshold value T3. When one of the gradients G1 to G4 is equal to or less than the threshold value T3, determines that a boundary between structures exists within or near the region “R” and determines the direction of the boundary between structures based on the direction in which the gradient is equal to or less than the threshold value T3.

As shown in FIG. 4, the amplitudes and phases of ultrasonic echoes at the pixels P11-P13 arranged in the second direction D2 are equal to one another, and the gradient G2 of the sound ray signals at the pixels P11-P33 arranged in the second direction D2 takes an extremely small value. On the other hand, the amplitudes and phases of ultrasonic echoes passing through the pixels arranged in the other directions are random, and the gradients G1, G3, G4 of the sound ray signals take relatively large values. Therefore, the gradient G2 is equal to or less than the threshold value T3, and thereby, the boundary between structures is detected. Further, it is found that the direction of the boundary between structures is nearly in parallel with the second direction D2 in which the gradient G2 of the sound ray signals is equal to or less than the threshold value T3.

Next, the second embodiment of the present invention will be explained.

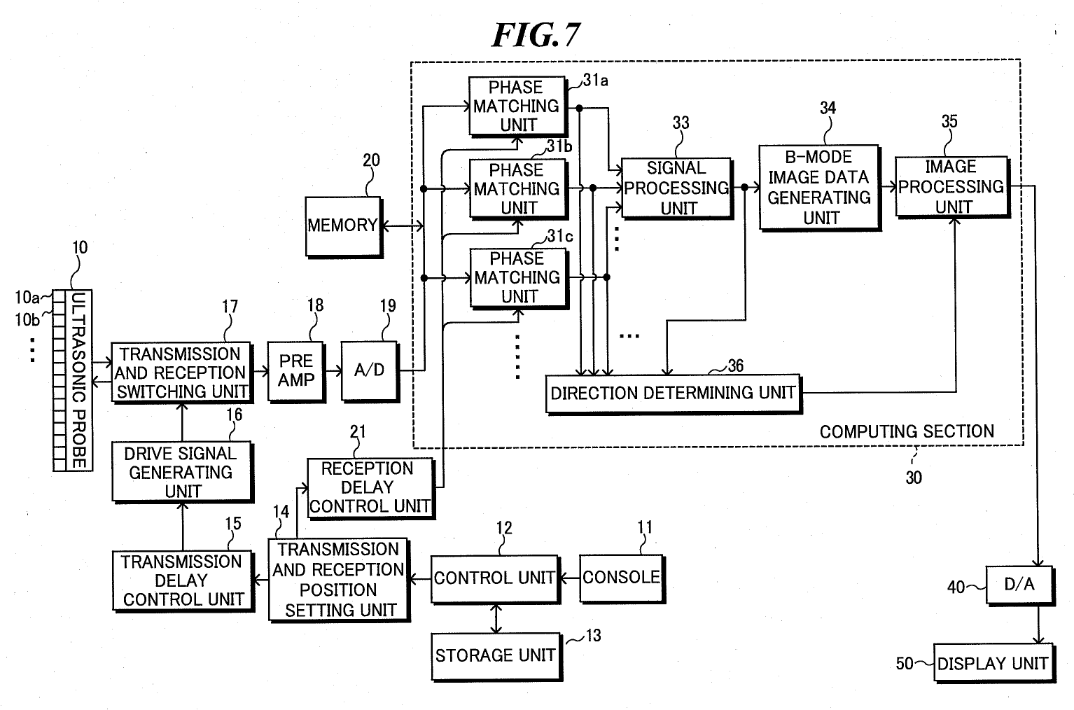

FIG. 7 is a block diagram showing a configuration of an ultrasonic diagnostic apparatus according to the second embodiment of the present invention. In the ultrasonic diagnostic apparatus according to the second embodiment, a direction determining unit 36 is provided in place of the direction determining unit 32.

The direction determining unit 36 sequentially sets regions having predetermined sizes surrounding each of the reception focuses (corresponding to pixels) sequentially formed by one of the phase matching units 31a, 31b, 31c, . . . in the imaging region, in order to determine the direction of a boundary between structures. The region is assumed to include M×N pixels. Further, the direction determining unit 36 determines the direction of the boundary between structures within the object based on phases of the sound ray signals generated by the phase matching units 31a, 31b, 31c, . . . and values of envelope signals (basically corresponding to amplitudes of the sound ray signals) generated by the signal processing unit 33 with respect to the M×N pixels within the respective regions. As below, the case where M=N=3 will be explained.

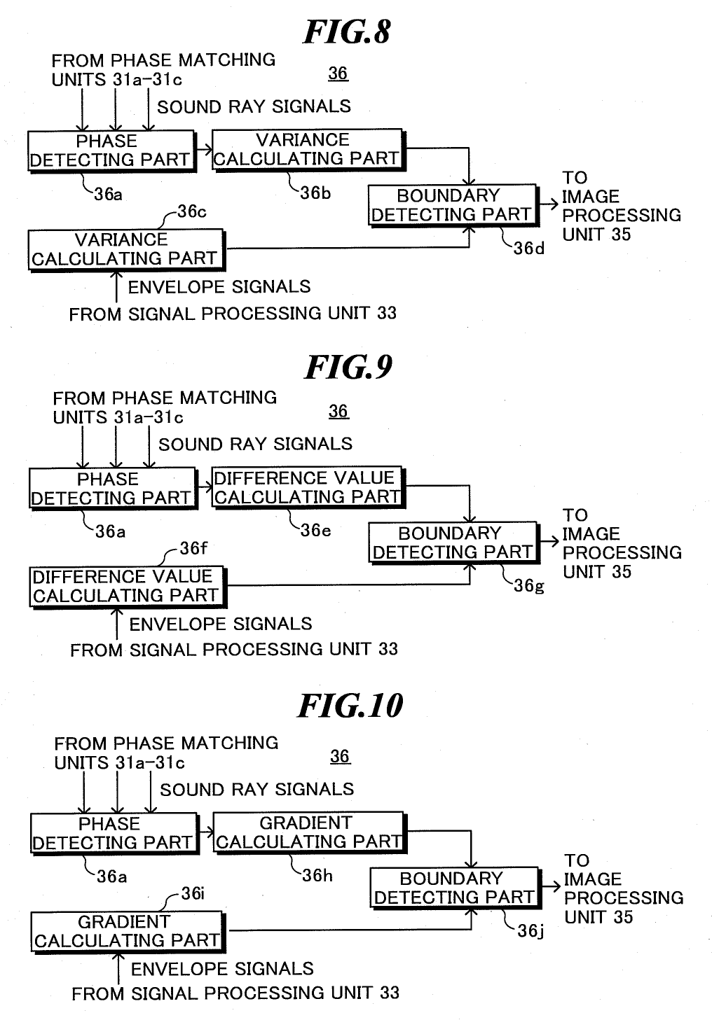

FIG. 8 is block diagram showing a first configuration example of the direction determining unit shown in FIG. 7. In the first configuration example, the direction determining unit 36 includes a phase detecting part 36a, variance calculating parts 36b and 36c, and a boundary detecting part 36d. The phase detecting part 36a extracts phase components of the sound ray signals by performing phase detection processing on the sound ray signals.

The variance calculating part 36b calculates variances σp of phases of the sound ray signals in plural different directions with respect to a predetermined number of pixels surrounding each of the reception focuses sequentially formed by the phase matching unit 31b. The variance calculating part 36c calculates variances σa of values of the envelope signals in plural different directions within the region. The boundary detecting part 36d detects a boundary between structures within the object based on the maximum value σp_{MAX} and the minimum value σp_{MIN} in the variances calculated by the variance calculating part 36b and the maximum value σa_{MAX} and the minimum value σa_{MIN} in the variances calculated by the variance calculating part 36c.

Referring to FIG. 3 again, the variance calculating part 36b calculates variance σp1 of the phases of the sound ray signals at the pixels P21-P23 arranged in the first direction D1, variance σp2 of the phases of the sound ray signals at the pixels P11-P33 arranged in the second direction D2, variance σp3 of the phases of the sound ray signals at the pixels P12-P32 arranged in the third direction D3, and variance σp4 of the phases of the sound ray signals at the pixels P13-P31 arranged in the fourth direction D4.

Further, the variance calculating part 36c calculates variance σa1 of the values of the envelope signals at the pixels P21-P23 arranged in the first direction D1, variance σa2 of the values of the envelope signals at the pixels P11-P33 arranged in the second direction D2, variance σa3 of the values of the envelope signals at the pixels P12-P32 arranged in the third direction D3, and variance σa4 of the values of the envelope signals at the pixels P13-P31 arranged in the fourth direction D4.

The boundary detecting part 36d calculates, using the maximum value σp_{MAX} and the minimum value σp_{MIN} among the variances σp1 to σp4 calculated by the variance calculating part 36b, a ratio of the maximum value to the minimum value σp_{MAX}/σp_{MIN} and compares the ratio with threshold value T4p. The difference between the maximum value and the minimum value (σp_{MAX}−σp_{MIN}) may be used in place of the ratio of the maximum value to the minimum value σp_{MAX}/σp_{MIN}.

Further, the boundary detecting part 36d calculates, using the maximum value σa_{MAX} and the minimum value σa_{MIN} among the variances σa1 to σa4 calculated by the variance calculating part 36c, a ratio of the maximum value to the minimum value σa_{MAX}/σa_{MIN} and compares the ratio with threshold value T4a. The difference between the maximum value and the minimum value (σa_{MAX}−σa_{MIN}) may be used in place of the ratio of the maximum value to the minimum value σa_{MAX}/σa_{MIN}.

When the ratio of the maximum value to the minimum value σp_{MAX}/σp_{MIN} is equal to or more than threshold value T4p and/or the ratio of the maximum value to the minimum value σa_{MAX}/σa_{MIN} is equal to or more than threshold value T4a, the boundary detecting part 36d determines that a boundary between structures exists within or near the region “R”, and determines the direction of the boundary between structures based on the direction that provides the minimum value σp_{MIN} or the minimum value σa_{MIN}.

As shown in FIG. 3, when the incident angle “α” of the transmission beam to the structure is zero, the phases of ultrasonic echoes passing through the pixels P21-P23 arranged in the first direction D1 are equal to one another, and the variance σp1 of the phases of the sound ray signals takes an extremely small value. On the other hand, the phases of ultrasonic echoes passing through the pixels arranged in the other directions are random, and the variances σp2 to σp4 of the phases of the sound ray signals take relatively large values.

Similarly, the amplitudes of the sound ray signals passing through the pixels P21-P23 arranged in the first direction D1 are equal to one another, and the variance σa1 of the values of the envelope signals takes an extremely small value. On the other hand, the amplitudes of ultrasonic echoes passing through the pixels arranged in the other directions are random, and the variances σa2 to σa4 of the values of the envelope signals take relatively large values.

Therefore, the ratio of the maximum value to the minimum value σp_{MAX}/σp_{MIN} in variances of the phases of the sound ray signals is equal to or more than threshold value T4p, and the ratio of the maximum value to the minimum value σa_{MAX}/σa_{MIN} in variances of the values of the envelope signals is equal to or more than threshold value T4a. Thereby, the boundary between structures is detected. Further, it is found that the direction of the boundary between structures is nearly in parallel with the first direction D1 that provides the minimum value σp_{MIN} and the minimum value σa_{MIN}.

On the other hand, as shown in FIG. 4, when the incident angle “α” of the transmission beam to the structure is 45°, the phases of ultrasonic echoes at the pixels P11-P33 arranged in the second direction D2 are equal to one another, and the variance σp2 of the phases of the sound ray signals takes an extremely small value. On the other hand, the phases of ultrasonic echoes passing through the pixels arranged in the other directions are random, and the variances σp1, σp3, σp4 of the phases of the sound ray signals take relatively large values.

Similarly, the amplitudes of the sound ray signals at the pixels P11-P33 arranged in the second direction D2 are equal to one another, and the variance σa2 of the values of the envelope signals takes an extremely small value. On the other hand, the amplitudes of ultrasonic echoes passing through the pixels arranged in the other directions are random, and the variances σa1, σa3, σa4 of the values of the envelope signals take relatively large values.

Therefore, the ratio of the maximum value to the minimum value σp_{MAX}/σp_{MIN} in the variances of the phases of the sound ray signals is equal to or more than the threshold value T4p and the ratio of the maximum value to the minimum value σa_{MAX}/σa_{MIN} in the variances of the values of the envelope signals is equal to or more than the threshold value T4. Thereby, the boundary between structures is detected. Further, it is found that the direction of the boundary between structures is nearly in parallel with the second direction D2 that provides the minimum value σp_{MIN} and the minimum value σa_{MIN}. The boundary detecting part 36d may determine the direction of the boundary between structures by calculating the weighted average of the direction of the boundary between structures calculated based on the variances of the phases of the sound ray signals and the direction of the boundary between structures calculated based on the variances of the values of the envelope signals.

FIG. 9 is a block diagram showing a second configuration example of the direction determining unit shown in FIG. 7. In the second configuration example, the direction determining unit 36 includes a phase detecting part 36a, difference value calculating parts 36e and 36f, and a boundary detecting part 36g.

The difference value calculating part 36e calculates differences ΔQ between the maximum values and the minimum values of the phases of the sound ray signals in plural different directions with respect to a predetermined number of pixels surrounding each of the reception focuses sequentially formed by the phase matching unit 31b. The difference value calculating part 36f calculates differences ΔA between the maximum values and the minimum values of the values of the envelope signals in plural different directions within the region. Alternatively, the boundary detecting part 36g detects a boundary between structures within the object based on the differences ΔQ between the maximum values and the minimum values calculated by the difference value calculating part 36e and the differences ΔA between the maximum values and the minimum values calculated by the difference value calculating part 36f.

Referring to FIG. 4 again, the difference value calculating part 36e calculates difference ΔQ1 between the maximum value and the minimum value of the phases of the sound ray signals at the pixels P21-P23 arranged in the first direction D1, difference ΔQ2 between the maximum value and the minimum value of the phases of the sound ray signals at the pixels P11-P33 arranged in the second direction D2, difference ΔQ3 between the maximum value and the minimum value of the phases of the sound ray signals at the pixels P12-P32 arranged in the third direction D3, and difference ΔQ4 between the maximum value and the minimum value of the phases of the sound ray signals at the pixels P13-P31 arranged in the fourth direction D4.

Further, the difference value calculating part 36f calculates difference ΔA1 between the maximum value and the minimum value of the values of the envelope signals at the pixels P21-P23 arranged in the first direction D1, difference ΔA2 between the maximum value and the minimum value of the values of the envelope signals at the pixels P11-P33 arranged in the second direction D2, difference ΔA3 between the maximum value and the minimum value of the values of the envelope signals at the pixels P12-P32 arranged in the third direction D3, and difference ΔA4 between the maximum value and the minimum value of the values of the envelope signals at the pixels P13-P31 arranged in the fourth direction D4.

The boundary detecting part 36g compares the differences ΔQ1 to ΔQ4 between the maximum values and the minimum values calculated by the difference value calculating part 36e with threshold value T5p, and the differences ΔA1 to ΔA4 between the maximum values and the minimum values calculated by the difference value calculating part 36f with threshold value T5a. When one of the differences ΔQ1 to ΔQ4 is equal to or less than the threshold value T5p and/or one of the differences ΔA1 to ΔA4 is equal to or less than the threshold value T5a, the boundary detecting part 36g determines that a boundary between structures exists within or near the region “R”, and determines the direction of the boundary between structures based on the direction in which the difference ΔQ is equal to or less than the threshold value T5p or the difference ΔA is equal to or less than the threshold value T5a.

As shown in FIG. 4, the phases of ultrasonic echoes at the pixels P11-P13 arranged in the second direction D2 are equal to one another, and the difference ΔQ2 between the maximum value and the minimum value of the phases of the sound ray signals at the pixels P11-P33 arranged in the second direction D2 takes an extremely small value. On the other hand, the phases of ultrasonic echoes passing through the pixels arranged in the other directions are random, and the differences ΔQ1, ΔQ3, ΔQ4 between the maximum values and the minimum values of the phases of the sound ray signals take relatively large values.

Similarly, the amplitudes of ultrasonic echoes at the pixels P11-P13 arranged in the second direction D2 are equal to one another, and the difference ΔA2 between the maximum value and the minimum value of the values of the envelope signals at the pixels P11-P33 arranged in the second direction D2 takes an extremely small value. On the other hand, the amplitudes of ultrasonic echoes passing through the pixels arranged in the other directions are random, and the differences ΔA1, ΔA3, ΔA4 between the maximum values and the minimum values of the values of the envelope signals take relatively large values.

Therefore, the difference ΔQ2 between the maximum value and the minimum value of the phases of the sound ray signals is equal to or less than the threshold value T5p, and thereby, the difference ΔA2 between the maximum value and the minimum value of the values of the envelope signals is equal to or less than the threshold value T5a. Thereby, the boundary between structures is detected. Further, it is found that the direction of the boundary between structures is nearly in parallel with the second direction D2 in which the difference ΔQ4 is equal to or less than the threshold value T5p and the difference ΔA4 is equal to or less than the threshold value T5a. Alternatively, the boundary detecting part 36g may determine the direction of the boundary between structures by calculating the weighted average of the direction of the boundary between structures calculated based on the differences between the maximum values and the minimum values of the phases of the sound ray signals and the direction of the boundary between structures calculated based on the differences between the maximum values and the minimum values of the values of the envelope signals.

FIG. 10 is a block diagram showing a third configuration example of the direction determining unit shown in FIG. 7. In the third configuration example, the direction determining unit 36 includes a phase detecting part 36a, gradient calculating parts 36h and 36i and a boundary detecting part 36j.

The gradient calculating part 36h calculates gradients Gp of the phases of the sound ray signals in plural different directions with respect to a predetermined number of pixels surrounding each of the reception focuses sequentially formed by the phase matching unit 31b. Further, the gradient calculating part 36i calculates gradients Ga of the values of the envelope signals in plural different directions within the region. The boundary detecting part 36j detects a boundary between structures within the object based on the gradients Gp calculated by the gradient calculating part 36h and the gradients Ga calculated by the gradient calculating part 36i.

Referring to FIG. 4 again, the gradient calculating part 36h calculates gradient Gp1 of the phases of the sound ray signals at the pixels P21-P23 arranged in the first direction D1, gradient Gp2 of the phases of the sound ray signals at the pixels P11-P33 arranged in the second direction D2, gradient Gp3 of the phases of the sound ray signals at the pixels P12-P32 arranged in the third direction D3, and gradient Gp4 of the phases of the sound ray signals at the pixels P13-P31 arranged in the fourth direction D4.

Further, the gradient calculating part 36i calculates gradient Ga1 of the values of the envelope signals at the pixels P21-P23 arranged in the first direction D1, gradient Ga2 of the values of the envelope signals at the pixels P11-P33 arranged in the second direction D2, gradient Ga3 of the values of the envelope signals at the pixels P12-P32 arranged in the third direction D3, and gradient Ga4 of the values of the envelope signals at the pixels P13-P31 arranged in the fourth direction D4.

The boundary detecting part 36j compares the gradients Gp1 to Gp4 calculated by the gradient calculating part 36h with threshold value T6p, and the gradients Ga1 to Ga4 calculated by the gradient calculating part 36i with threshold value T6a. When one of the gradients Gp1 to Gp4 is equal to or less than the threshold value T6p and/or one of the gradients Ga1 to Ga4 is equal to or less than the threshold value T6a, the boundary detecting part 36j determines that a boundary between structures exists within or near the region “R”, and determines the direction of the boundary between structures based on the direction in which the gradient Gp is equal to or less than the threshold value T6p or the gradient Ga is equal to or less than the threshold value T6a.

As shown in FIG. 4, the phases of ultrasonic echoes at the pixels P11-P33 arranged in the second direction D2 are equal to one another, and the gradient Gp2 of the phases of the sound ray signals at the pixels P11-P33 arranged in the second direction D2 takes an extremely small value. On the other hand, the phases of ultrasonic echoes passing through the pixels arranged in the other directions are random, and the gradients Gp1, Gp3, Gp4 of the phases of the sound ray signals take relatively large values.

Similarly, the amplitudes of ultrasonic echoes at the pixels P11-P33 arranged in the second direction D2 are equal to one another, and the gradient Ga2 of the values of the envelope signals at the pixels P11-P33 arranged in the second direction D2 takes an extremely small value. On the other hand, the amplitudes of ultrasonic echoes passing through the pixels arranged in the other directions are random, and the gradients Gp1, Gp3, Gp4 of the values of the envelope signals take relatively large values.

Therefore, the gradient Gp2 is equal to or less than the threshold value T6p, and the gradient Ga2 is equal to or less than the threshold value T6a. Thereby, the boundary between structures is detected. Further, it is found that the direction of the boundary between structures is nearly in parallel with the second direction D2 in which the gradient Gp2 is equal to or less than the threshold value T6p and the Ga2 is equal to or less than the threshold value T6p. Alternatively, the boundary detecting part 36j may detect a boundary between structures within the object by calculating the weighted average of the direction of the boundary between structures calculated based on the differences between the maximum values and the minimum values of the phases of the sound ray signals and the direction of the boundary between structures calculated based on the differences between the maximum values and the minimum values of the values of the envelope signals.

As above, the case where M=N=3 has been explained, however, the direction of a structure can be determined more correctly by increasing the values of M and N. Further, the case where image processing is performed on the image data outputted from the B-mode image data generating unit 34 has been explained, however, the image processing unit 35 may perform image processing on the sound ray signals outputted from the signal processing unit 33.

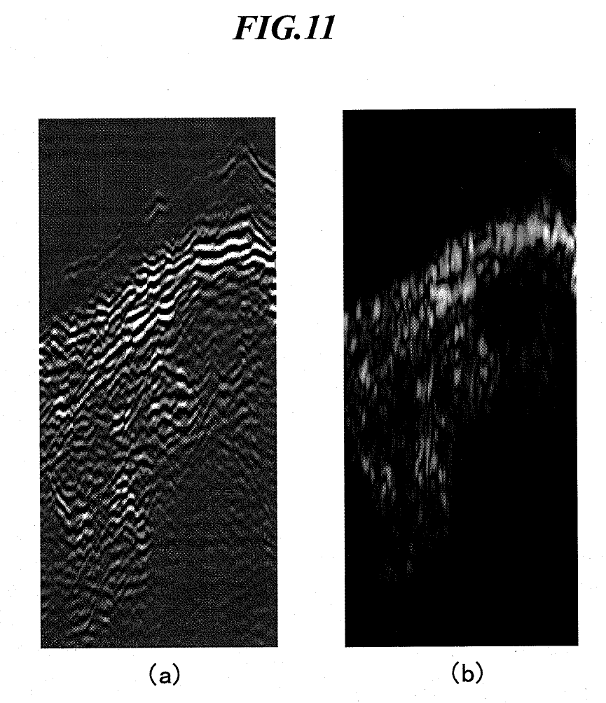

FIG. 11 shows a difference in amount of information between sound ray signals and envelope signals. FIG. 11 (a) shows an ultrasonic image represented by sound ray signals obtained by performing reception focus processing on reception signals (RF data) of plural channels, while FIG. 11 (b) shows an ultrasonic image represented by envelope signals obtained by performing envelope detection processing on the sound ray signals.

As shown in FIG. 11 (a), wave surfaces of the sound ray signals are uniform near the boundary between structures because of spatial boundary continuity, while wave surfaces of the sound ray signals are not uniform apart from the boundary between structures. This is reflected to phase information of the sound ray signals, and thus, the boundary between structures can be detected and the direction of the boundary can be determined by utilizing the phase information of the sound ray signals. Further, since the frequency of the sound ray signal is higher than the highest frequency of the envelope signal, by utilizing the phase information of the sound ray signals to detect the boundary between structures results in higher detection accuracy than in the case of utilizing envelope signals.

1. An ultrasonic diagnostic apparatus comprising:
a transmission and reception unit for respectively supplying drive signals to plural ultrasonic transducers for transmitting ultrasonic waves to an object to be inspected, and converting reception signals respectively outputted from said plural ultrasonic transducers having received ultrasonic echoes from the object into digital signals;
phase matching means for performing reception focus processing on the digital signals to generate sound ray signals corresponding to plural reception lines;
signal processing means for performing envelope detection processing on the sound ray signals generated by said phase matching means to generate envelope signals;
image data generating means for generating image data based on the envelope signals generated by said signal processing means;
direction determining means for determining a direction of a boundary between structures within the object based on the sound ray signals generated by said phase matching means; and
image processing means for performing image processing on one of the envelope signals and the image data according to a determination result obtained by said direction determining means.

2. The ultrasonic diagnostic apparatus according to claim 1, wherein said direction determining means includes:
variance calculating means for calculating variances of values of the sound ray signals in plural different directions with respect to a predetermined number of pixels surrounding each of reception focuses sequentially formed by said phase matching means; and
boundary detecting means for detecting the boundary between structures within the object based on a maximum value and a minimum value in the variances calculated by said variance calculating means.

3. The ultrasonic diagnostic apparatus according to claim 1, wherein said direction determining means includes:
difference value calculating means for calculating differences between maximum values and minimum values of values of the sound ray signals in plural different directions with respect to a predetermined number of pixels surrounding each of reception focuses sequentially formed by said phase matching means; and
boundary detecting means for detecting the boundary between structures within the object based on the differences between the maximum values and the minimum values calculated by said difference value calculating means.

4. The ultrasonic diagnostic apparatus according to claim 1, wherein said direction determining means includes:
gradient calculating means for calculating gradients of values of the sound ray signals in plural different directions with respect to a predetermined number of pixels surrounding each of reception focuses sequentially formed by said phase matching means; and
boundary detecting means for detecting the boundary between structures within the object based on the gradients calculated by said gradient calculating means.

5. An ultrasonic diagnostic apparatus comprising:
a transmission and reception unit for respectively supplying drive signals to plural ultrasonic transducers for transmitting ultrasonic waves to an object to be inspected, and converting reception signals respectively outputted from said plural ultrasonic transducers having received ultrasonic echoes from the object into digital signals;
phase matching means for performing reception focus processing on the digital signals to generate sound ray signals corresponding to plural reception lines;
signal processing means for performing envelope detection processing on the sound ray signals generated by said phase matching means to generate envelope signals;
image data generating means for generating image data based on the envelope signals generated by said signal processing means;
direction determining means for determining a direction of a boundary between structures within the object based on phases of the sound ray signals generated by said phase matching means and values of the envelope signals generated by said signal processing means; and
image processing means for performing image processing on one of the envelope signals and the image data according to a determination result obtained by said direction determining means.

6. The ultrasonic diagnostic apparatus according to claim 5, wherein said direction determining means includes:
first variance calculating means for calculating variances of phases of the sound ray signals in plural different directions with respect to a predetermined number of pixels surrounding each of reception focuses sequentially formed by said phase matching means;
second variance calculating means for calculating variances of values of the envelope signals in the plural different directions with respect to said predetermined number of pixels; and
boundary detecting means for detecting the boundary between structures within the object based on a maximum value and a minimum value in the variances calculated by said first variance calculating means and a maximum value and a minimum value in the variances calculated by said second variance calculating means.

7. The ultrasonic diagnostic apparatus according to claim 5, wherein said direction determining means includes:
first difference value calculating means for calculating differences between maximum values and minimum values of phases of the sound ray signals in plural different directions with respect to a predetermined number of pixels surrounding each of reception focuses sequentially formed by said phase matching means;
second difference value calculating means for calculating differences between maximum values and minimum values of values of the envelope signals in the plural direction with respect to said predetermined number of pixels; and
boundary detecting means for detecting the boundary between structures within the object based on the differences between the maximum values and the minimum values calculated by said first difference value calculating means and the differences between the maximum values and the minimum values calculated by said second difference value calculating means.

8. The ultrasonic diagnostic apparatus according to claim 5, wherein said direction determining means includes:
first gradient calculating means for calculating gradients of phases of the sound ray signals in plural different directions with respect to a predetermined number of pixels surrounding each of reception focuses sequentially formed by said phase matching means;
second gradient calculating means for calculating gradients of values of the envelope signals in the plural different directions with respect to said predetermined number of pixels; and
boundary detecting means for detecting the boundary between structures within the object based on the gradients calculated by said first gradient calculating means and the gradients calculated by said second gradient calculating means.

9. The ultrasonic diagnostic apparatus according to claim 2, wherein said image processing means performs smoothing processing on a region in which no boundary between structures has been detected by said boundary detecting means.

10. The ultrasonic diagnostic apparatus according to claim 3, wherein said image processing means performs smoothing processing on a region in which no boundary between structures has been detected by said boundary detecting means.

11. The ultrasonic diagnostic apparatus according to claim 4, wherein said image processing means performs smoothing processing on a region in which no boundary between structures has been detected by said boundary detecting means.

12. The ultrasonic diagnostic apparatus according to claim 6, wherein said image processing means performs smoothing processing on a region in which no boundary between structures has been detected by said boundary detecting means.

13. The ultrasonic diagnostic apparatus according to claim 7, wherein said image processing means performs smoothing processing on a region in which no boundary between structures has been detected by said boundary detecting means.

14. The ultrasonic diagnostic apparatus according to claim 8, wherein said image processing means performs smoothing processing on a region in which no boundary between structures has been detected by said boundary detecting means.

15. The ultrasonic diagnostic apparatus according to claim 1, wherein said image processing means performs smoothing processing in a direction in parallel with the direction of the boundary between structures determined by said direction determining means.

16. The ultrasonic diagnostic apparatus according to claim 1, wherein said image processing means performs edge enhancement processing in a direction orthogonal to the direction of the boundary between structures determined by said direction determining means.
